(19) United States
(12) Patent Application Publication
(10) Pub. No.: US 2003/0219519 A1
(43) Pub. Date: Nov. 27, 2003

(54) Antioxidant containing food product

(76) Inventor: Theodore Hersh, Atlanta, GA (US)

Correspondence Address: DERGOSITS & NOAH LLP, Suite 1450, Four Embarcadero Center, San Francisco, CA, 94111, US

(21) Appl. No.: 10/155,341

(22) Filed: May 23, 2002

(51) Int. Cl. A23B 4/00

(52) U.S. Cl. 426/544

(57) ABSTRACT

A method of extending the antioxidant value of an ingestible food product is disclosed. The food product includes at least one antioxidant while the method involves adding to the food product a thiol in an amount suitable for extending the antioxidant value of the food product. Ideally, the food product is a liquid fruit drink such as orange juice, lemonade, grapefruit juice, cranberry juice and apple juice, although any such product that includes one or more antioxidants can benefit from the practice of the present invention.

### TECHNICAL FIELD OF THE INVENTION

The present invention is involved with extending the antioxidant value of an ingestible food product by adding a thiol to the food product. The thiol acts to extend the antioxidant value of antioxidants, such as vitamin C and vitamin E, by retarding oxidation of these naturally occurring vitamins.

### BACKGROUND OF THE INVENTION

The role played by antioxidants in maintaining the overall health of living species cannot be overly emphasized. The mere aging process results in the creation of free radicals which can cause cell damage. Free radicals can produce harmful oxidation that can damage cell membranes and the cells themselves. People who eat recommended daily requirements of fruits and vegetables high in antioxidants are known to have a lower incidence of cardiovascular disease, certain cancers and neurodegenerative diseases. As such, in recognizing the important role played by antioxidants, nutritionalists have emphasized the importance of consuming food products such as fruits and vegetables rich in antioxidants such as ascorbic acid (vitamin C), tocopherols (vitamin E) and beta-carotene, which the body converts to vitamin A. Evidence exists that vitamin E can help prevent arteriosclerosis by inhibiting the oxidation of low-density lipoproteins (LDL) which is also associated with heart disease.

Vitamin C is soluble in aqueous media and is naturally occurring in, for example, orange juice. Recognizing its importance, there have been suggestions made that this vitamin, as well as other natural occurring water soluble antioxidants, be modified to be included in a fat or non-aqueous medium. In this regard, reference is made to U.S. Pat. No. 5,084,293 which clearly acknowledges the value of such naturally occurring vitamins to a recipient's health and well-being. In this regard, it is well recognized that antioxidants, such as vitamins C and E, in their reduced form, promote the metabolic functions of cells.

The need for antioxidant consumption is particularly enhanced for smokers and others subjected to environmental stress such as the increasing pollution levels found in modem urban settings. The role that antioxidants play in this regard is well discussed in applicant's previously issued U.S. Pat. No. 5,906,811, the disclosure of which is incorporated by reference herein.

It is well recognized that dietary vitamin antioxidants such as L-ascorbic acid, tocopherols and other vitamins can be important in reducing free radicals and inhibiting tissue metabolic oxidation. What is not recognized, however, is that these vitamin antioxidants are prone to oxidation resulting in not only a loss in physiological activity but that these same antioxidants, can themselves, promote cell oxidation as a result of their conversation from reduced to oxidized states. This can occur simply over time without any external stimuli. For example, if orange juice remains on a store shelf too long, the L-ascorbic acid contained therein can be oxidized to its ascorbate resulting in a further source of oxidation rather than as a neutralizer of free radicals.

It is thus an object of the present invention to provide a method of extending the antioxidant value of ingestible food products that include at least one antioxidant.

This and further objects will be more readily apparent when considering the following disclosure and appended claims.

### SUMMARY OF THE INVENTION

The present invention is directed to a method of extending the antioxidant value of ingestible food products that include at least one antioxidant. The method comprises adding to the food products, at least one thiol in an amount suitable for extending the antioxidant value of the food products.

### DESCRIPTION OF THE INVENTION

Vitamins such as L-ascorbic acid (vitamin C) and its derivatives, as well as tocopheral (vitamin E), have been employed primarily for their antioxidant characteristics. However, vitamin C and other commonly employed antioxidants lose their physiological reducing activities because of their high susceptibility to oxidation.

There have been minimum daily requirements established for adults of antioxidant vitamins. However, there are many individuals that require supplemental antioxidant vitamins, such as cigarette smokers and those exposed to toxic environmental pollutants. These vitamins play a major role in human metabolism. As antioxidants, they protect the skin from free radical damage induced by radiation, tobacco smoke and other inhaled or injected environmental pollutants. These vitamins promote collagen synthesis, tissue repair and wound healing. They also render important protection against damaging chemicals associated with environmental pollutants, such as smoking, including nicotine, carbon monoxide, nitrogen oxides, nitric acid gas and others. For example, it has been known that cigarette smokers often have lower plasma levels of ascorbic acid than matched non-smoking controls. Clinical and investigative evidence suggest that smokers may have a higher ascorbic acid requirement and that supplementing dietary vitamin C may be protective to the smoker. In vitro studies suggest that antioxidants and reducing substances may prevent the removal of elastase inhibitor capacity induced by cigarette smoke. Naturally occurring antioxidants such as lycopene in tomatoes or vitamin C in oranges have shown to reduce the risks of developing various diseases such as cardiovascular and neurodegenerative diseases and various cancers, thus increasing the life span of a consumer of such vitamins. As such, these vitamins are referred to as having anti-aging properties primarily as a result of their ability to scavenge reactive oxygen species and other toxic free radicals that increase in the body as the aging process continues.

Recognizing the value of antioxidant vitamins, a variety of food stuffs have been fortified or enriched by adding additional antioxidant vitamins such as vitamin C to citrus products like orange juice or vitamins A and B to milk. For example, Tropicana® brand orange juice is available in three varieties, one containing “double” vitamin C, a second containing vitamin C and calcium and a third containing vitamins C and E. Ocean Spray® brand cranberry juice is available in a specific “antioxidant” formulation containing among other vitamins, vitamin C. Hi-C® fruit drink, available from Minute Maid, is shown to contain added vitamin C while Motts® apple juice is again shown to be fortified with vitamin C. This is a clear recognition that antioxidant vitamins are beneficial in maintaining the overall health of a consumer.

As noted previously, various vitamins are readily oxidized through the mere passage of time and, in their oxidized state, tend to be more destructive to the user than if the vitamins did not exist in the formulated food product in the first instance. It has now been recognized that thiols can be incorporated in antioxidant-containing food products such as juice, water, milk, ice cream and various formulated drinks to retard oxidation of the contained antioxidants, thus extending the antioxidant value of the food products. This can act to extend the shelf life of the products and increase their concentration of the reduced form of the subject antioxidants providing benefit to the consumer well beyond the antioxidant benefit which would otherwise have been derived without the incorporation of the subject thiols.

The thiols, such as L-glutathione, L-cysteine, N-acetyl-L-cysteine, alpha lipoic acid, dihydrolipoic acid, thioredoxin and their derivatives can be employed in their reduced forms either alone or encapsulated in liposomes, nanosomes, microspheres as well as other microencapsulators known in this industry.

The thiols are included in amounts to neutralize vitamin free radicals, such as the oxidized molecule, dihydroascorbate, derived from the (reduced) antioxidant form of vitamin C, ascorbic acid. As such, sufficient thiol is added to the food product in concentrations calculated to neutralize the vitamin free radicals. Further, additional thiols can be included to create an additive antioxidant function in the food product itself. It is thus contemplated that the thiols be included within the food product in a concentration (by volume) of from 0.01 to 10%, 0.1 to 2.5% and more preferably 0.5 to 1%. Typical food products employed herein include fruit and vegetable juices such as orange juice, lemonade, apple, cranberry and grapefruit juices, waters having antioxidant vitamins added thereto, protein drinks including those containing whey protein and soy protein and various desserts including ice creams, ices, sorbets and smoothies.

As noted previously, the value of antioxidants such as vitamin C in their reduced form is recognized as promoting certain benefits in the oral cavity of smokers. For example, in saliva, cigarette smoke modifies salivary proteins as evidenced by increases in proteins and protein carbonyl species and in decreases of salivary enzyme activities, such as those of LDH isoenzymes and amylase. It is hypothesized that aldehydes contained in smoke induce protein carbonyls and their deleterious effects can be lessened by consumption of thiol compounds such as glutathione and N-acetyl-L-cysteine. Surprisingly, it was found that vitamin C does not protect salivary proteins from these aldehydes. Instead, vitamin C enhances the injurious effect on salivary amylase and LDH enzymes to a greater extent than the smoke itself, indicated that vitamin C is being oxidized in the oral cavity by the cigarette smoke and by the metals in saliva like iron and copper by the cigarette oxidation of vitamin C. Through the practice of the present invention, oxidation of vitamin C is diminished by chelating the iron or by reducing the oxidized vitamin C (dehydroscorbate) to the antioxidant form of vitamin C (ascorbic acid) by the specific reducing capacity of the thiols. Thus, the addition of thiols to a food product containing an antioxidant vitamin keeps the antioxidant vitamin in its reduced, molecular state, capable of functioning as an antioxidant rather than an oxidized free radical species. Certainly this situation is exacerbated if the vitamin sought to express antioxidant activity is itself oxidized while remaining in the food product on a grocery shelf prior to consumption.

What is claimed is:

1. A method of extending antioxidant value of an ingestible food product, such food product including at least one antioxidant, said method comprising adding to said food product a thiol in amount suitable for extending said antioxidant value.

2. The method of claim 1 wherein said thiol comprises a member selected from the group consisting of L-glutathione, N-acetyl-L-cysteine, alpha lipoic acid, L-cysteine, dihydrolipoic acid, thioredoxin and their derivatives.

3. The method of claim 1 wherein said at least one antioxidant comprises a member selected from the group consisting of vitamin C and vitamin E.

4. The method of claim 1 wherein said ingestible food product comprises a liquid food product in the form of a fruit drink.

5. The method of claim 4 wherein said fruit drink comprises a member selected from the group consisting of orange juice, grapefruit juice, cranberry juice, lemonade and apple juice.

6. The method of claim 1 wherein said food product comprises a liquid carrier for said at least one antioxidant.

7. The method of claim 6 wherein said liquid carrier comprises water.

8. The method of claim 1 wherein said food product comprises a protein drink.

9. The method of claim 1 wherein said food product comprises a member selected from the group consisting of ice cream, ices, sorbets and smoothies.

10. The method of claim 1 wherein said thiol is microencapsulated prior to its inclusion in said food product.

11. The method of claim 10 wherein said thiol is microencapsulated in a member selected from the group consisting of liposomes, nanosomes and microspheres.

12. The method of claim 1 wherein said thiol is contained within said food product in an amount between approximately 0.01 to 10% by volume.

13. The method of claim 1 wherein said thiol is contained within said food product in an amount between approximately 0.1 to 2.5% by volume.

14. The method of claim 1 wherein said thiol is contained within said food product in an amount between approximately 0.5 to 1% by volume.
